(19) United States
(12) Patent Application Publication
(10) Pub. No.: US 2018/0254152 A1
(43) Pub. Date: Sep. 6, 2018

(54) COMPOSITION FOR GEL ELECTROLYTES

(71) Applicant: OSAKA SODA CO., LTD., Osaka-shi, Osaka (JP)

(72) Inventors: Takashi MATSUO, Osaka-shi, Osaka (JP); Masato TABUCHI, Osaka-shi, Osaka (JP); Hideaki UEDA, Osaka-shi, Osaka (JP)

(21) Appl. No.: 15/756,512

(22) PCT Filed: Sep. 29, 2016
(86) PCT No.: PCT/JP2016/078873

§ 371 Date: Feb. 28, 2018

(30) Foreign Application Priority Data
Sep. 30, 2015 (JP) 2015-192468

(51) Int. Cl. H01G 11/56; H01G 11/84; C08J 3/075; C08K 5/3445; C08K 5/435; C08G 65/22

(52) U.S. Cl. CPC H01G 11/56; H01G 11/84; C08J 3/075; C08K 5/3445; C08K 5/435; H01G 11/06; C08J 2371/02; C08G 2650/64; C08G 2650/66; C08G 2650/38; C08G 65/22

(57) ABSTRACT

There is provided a composition for gel electrolyte that can impart excellent power characteristics and a high capacity retention ratio to an electrochemical capacitor. The composition for gel electrolyte comprises an electrolyte salt and a polyether copolymer having an ethylene oxide unit, wherein the composition for gel electrolyte has a water content of 50 ppm or less.

### TECHNICAL FIELD

The present invention relates to a composition for gel electrolyte. More particularly, the present invention relates to a composition for gel electrolyte that can impart excellent power characteristics and a high capacity retention ratio to an electrochemical capacitor. Furthermore, the present invention relates to a method for producing the composition for gel electrolyte, an electrochemical capacitor comprising the composition for gel electrolyte, and a method for producing the electrochemical capacitor.

### BACKGROUND ART

The development of secondary batteries or electrochemical capacitors is actively ongoing for use as main power supplies or auxiliary power supplies for vehicles such as electric vehicles (EVs) or hybrid vehicles (HEVs), or electric power storage devices for storing renewable energy such as energy generated by solar power or wind power generation. Known electrochemical capacitors include electric double-layer capacitors and hybrid capacitors. For example, in an electric double-layer capacitor (sometimes also referred to as a “symmetric capacitor”), a material with a large specific surface area such as activated carbon is used for both cathode and anode layers. An electrical double layer is formed at the interface between each of the electrode layers and the electrolytic solution, whereby electricity' is stored by a non-Faradaic reaction that does not involve a redox reaction. In general, electric double-layer capacitors have higher power densities and better rapid charge-discharge characteristics than secondary batteries.

The electrostatic energy, J, of an electric double-layer capacitor is defined by the equation: J=(1/2)×CV², wherein C is the electrostatic capacitance, and. V is the voltage. The voltage of the electric double-layer capacitor is low, i.e., about 2.7 to 3.3 V. Thus, the electrostatic energy of the electric double-layer capacitor is not more than 1/10 that of a secondary battery.

Furthermore, for example, in a hybrid capacitor (also sometimes referred to as an “asymmetric capacitor”), a cathode layer and an anode layer, which are composed of different materials, are opposed to each other with a separator sandwiched therebetween, in an electrolytic solution containing lithium ions. With this structure, a large electrostatic capacitance, C, can be produced by storing electricity by a non-Faradaic reaction that does not involve a redox reaction in the cathode layer, while storing electricity by a Faradaic reaction that involves a redox reaction in the anode layer. Thus, such a hybrid capacitor is expected to achieve a higher energy density than an electric double-layer capacitor.

However, because an electrochemical capacitor conventionally uses an electrolyte in the form of a solution in view of its ionic conductivity, it may cause damage to devices due to liquid leakage. This necessitates various safety measures, and presents a barrier to the development of large capacitors.

As a solution to this, Patent Literature 1, for example, proposes a solid electrolyte such as an organic polymer--based material. In Patent Literature 1, because the solid electrolyte is used instead of a liquid electrolyte, problems such as liquid leakage do not occur, which is advantageous in terms of safety. This solid electrolyte, however, suffers from a reduced ionic conductivity. Additionally, the use of a separator results in a small electrostatic capacitance.

Patent Literature 2, for example, proposes an electrochemical capacitor produced by forming voids by removing a salt of an ion-exchange resin, and filling the voids with an electrolytic solution. This method, however, requires an extra step to prepare the voids. Additionally, expertise is required for injecting the electrolytic solution into the voids, making the production of the electrochemical capacitor very difficult.

Patent Literature 3, for example, proposes an electrochemical capacitor comprising a gel electrolyte containing a specific organic polymer electrolyte.

### CITATION LIST

### Patent Literature

Patent Literature 1: JP 2000-150308 A.
Patent Literature 2: JP 2006-73980A
Patent Literature 3: JP 2013475701 A

### SUMMARY OF INVENTION

### Technical Problem

The gel electrolyte as described above is required to impart excellent power characteristics and a high capacity retention ratio to an electrochemical capacitor.

In view of the above-described circumstances, it is a main object of the present invention to provide a composition for gel electrolyte that can impart excellent power characteristics and a high capacity retention ratio to an electrochemical capacitor. It is another object of the present invention to provide a method for producing the composition for gel electrolyte, an electrochemical capacitor comprising the composition for gel electrolyte, and a method for producing the electrochemical capacitor.

### Solution to Problem

The inventors of the present invention conducted extensive research to solve the aforementioned problem. As a result, the inventors found that a composition for gel electrolyte comprising an electrolyte salt and a polyether copolymer having an ethylene oxide unit, wherein the composition for gel electrolyte has a water content of 50 ppm or less, can impart excellent power characteristics and a high capacity retention ratio to an electrochemical capacitor. The present invention was completed as a result of further research based on these findings.

In summary, the present invention provides aspects of invention as itemized below.

Item 1. A composition for gel electrolyte comprising an electrolyte salt and a polyether copolymer having an ethylene oxide unit, wherein

the composition for gel electrolyte has a water content of 50 ppm or less.

Item 2. The composition for gel electrolyte according to item 1, Wherein the electrolyte salt comprises an ambient temperature molten salt.

Item 3. The composition for gel electrolyte according to item 1 or 2, wherein the polyether copolymer comprises:

0 to 89.9 mol % of a repeating unit represented by Formula (A):

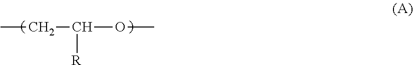

wherein R is a C₁₋₁₂ alkyl group or a —CH₂O(CR¹R²R³) group; R¹, R², and R³ are each independently a hydrogen atom or a —CH₂O(CH₂O(CH₂CH₂O)ₙR⁴ group; R⁴ is a C₁₋₁₂ alkyl group or an aryl group optionally having a substituent; and n is an integer from 0 to 12;

99 to 10 mol % of a repeating unit represented by Formula (B):

CH₂—CH₂—O (B)

; and

0.1 to 15 mol % of a repeating unit represented by Formula (C):

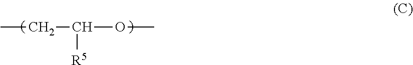

wherein R⁵ is a group containing an ethylenically unsaturated group.

Item 4. A method for producing the composition for gel electrolyte according to any one of items 1 to 3, comprising the step of:

mixing the electrolyte salt and the polyether copolymer, wherein

the electrolyte salt has a water content of 30 ppm or less.

Item 5. A method for producing the composition for gel electrolyte according to any one of items 1 to 4, comprising the step of:

mixing the electrolyte salt and the polyether copolymer, wherein

the polyether copolymer has a water content of 200 ppm or less.

Item 6. An electrochemical capacitor comprising, between a cathode and an anode, a gel electrolyte layer comprising a cured product of the composition for gel electrolyte according to any one of items 1 to 3.

Item 7. The electrochemical capacitor according to item , wherein the gel electrolyte layer has a thickness of 1 to 50 μm.

Item 8. A method for producing an electrochemical capacitor comprising the steps of:

applying the composition for gel electrolyte according to any one of items 1 to 3 to a surface of at least one of a cathode and an anode;

forming a gel electrolyte layer by irradiating the composition for gel electrolyte with active energy rays to cure the composition for gel electrolyte; and

laminating the cathode and the anode with the gel electrolyte layer sandwiched therebetween.

### Advantageous Effects of Invention

According to the present invention, because the composition for gel electrolyte comprises an electrolyte salt and a polyether copolymer having an ethylene oxide unit, wherein the composition for gel electrolyte has a water content of 50 ppm or less, the composition for gel electrolyte can impart excellent power characteristics and a high capacity retention ratio to an electrochemical capacitor. That is, an electrochemical capacitor comprising the composition for gel electrolyte of the present invention has excellent power characteristics and a high capacity retention ratio.

### DESCRIPTION OF EMBODIMENTS

1. Composition for Gel electrolyte

The composition for gel electrolyte of the present invention comprises an electrolyte salt and a polyether copolymer having an ethylene oxide unit, wherein the composition for gel electrolyte has a water content of 50 ppm or less. The composition for gel electrolyte of the present invention will be hereinafter described in detail.

When the composition for gel electrolyte of the present invention, which has an extremely low water content, is used for an electrochemical capacitor, the voltage of the electrochemical capacitor can be favorably increased to the upper limit voltage during charging; therefore, the composition for gel electrolyte of the present invention can impart excellent power characteristics and a high capacity retention ratio to an electrochemical capacitor. For example, as described below, although polyether copolymers are polymers having an extremely high water absorption capacity, the water content in conventional polyether copolymers used in composition for gel electrolytes has not been controlled to be extremely low, i.e., 50 ppm or less. In the present invention, for example, as described below, a composition for gel electrolyte having an extremely low water content, i.e., 50 ppm or less, can be obtained by using a specific raw material whose water content is controlled, or by preparing a composition for gel electrolyte using a specific method.

Examples of methods for setting the water content in the composition for gel electrolyte of the present invention to 50 ppm or less include a method that involves adjusting the water content in, for example, the step of washing the electrolytic solution, the polyether copolymer having an ethylene oxide unit, or the like used as a raw material, the step of contacting the raw materials or the composition for gel electrolyte solution with an adsorbent, or the step of drying. Each of these steps will be described in the mentioned order.

For example, in the step of washing the electrolytic solution, the polyether copolymer, or the like, the electrolytic solution or the polyether copolymer is dissolved, in an organic solvent that is a good solvent, the solution is mixed with a poor solvent, and the mixture is subjected to separation or filtration to wash off impurities. When water is used as the poor solvent, ion-exchange water having a specific resistance of 1×10⁷ Ω·cm or more is preferably used. If the specific resistance of the ion-exchange water is small, impurities from the ion-exchange water may mix into the electrolytic solution, the polyether copolymer, or the like. The ion-exchange water preferably has a temperature of 25 to 50° C.

In the washing step, the amount of the poor solvent used at a time is preferably 30 to 50 parts by mass per part, by mass of the raw material. If the amount of the poor solvent used is less than 30 parts by mass, sufficient washing is not accomplished; conversely, if the amount is over 50 parts by mass, the effect will not significantly change, and the use of a large amount of poor solvent will make the treatment difficult to perform, and increase costs.

Examples of the good solvent include toluene, tetrahydrofuran (THF), acetonitrile, acetone, and methyl ethyl ketone. Examples of the poor solvent include hexane, cyclohexane, carbon tetrachloride, methyl monoglyme, and ethyl monoglyme. Among the above, a combination of a good solvent and a poor solvent is used whose boiling points are low and relatively separate from each other.

In the step of contacting the raw materials or the composition for gel electrolyte solution with an adsorbent, the raw materials after the washing step or the composition for gel electrolyte is contacted with an adsorbent (preferably a porous adsorbent, for example, at least one material selected from zeolite, alumina, molecular sieves, and silica gels) to remove the water in the solution.

In the step of contacting the raw materials or the composition for gel electrolyte solution with an adsorbent, the treatment may be performed by placing an adsorbent in a funnel or the like, and then contacting the raw materials or the composition for gel electrolyte solution with the adsorbent simultaneously with a filtration procedure. This allows the removal of the water in the organic solvent and the removal of solid impurities to be performed simultaneously.

In the drying step, the polyether copolymer or the composition for gel electrolyte treated in the step of contacting it with an adsorbent is dried under reduced pressure at a medium to high temperature. The drying step is intended to remove unwanted organic solvent in the electrolytic solution or the polyether copolymer.

Thus, the temperature in the drying step is preferably a predetermined temperature at which the electrolytic solution does not evaporate, or the composition for gel electrolyte is not reacted (cured or cross-linked). By drying the composition for gel electrolyte while stirring under reduced pressure at room temperature or higher, the electrolytic solution and the polyether copolymer can be uniformly mixed in the composition for gel electrolyte. This is important to improve the charge-discharge characteristics of an electrochemical capacitor. Drying is particularly preferably performed under a reduced pressure of 0.1 to 0.2 torr at 40 to 50° C., in view of the above.

After the drying step, it is preferred to charge the surroundings of the composition for gel electrolyte under reduced pressure with at least one gas of dry air and an inert gas (preferably nitrogen gas or argon gas). This is intended to prevent re-adsorption of water and the like on the purified composition.

Likewise, after the drying step, if the composition for gel electrolyte is transferred into another container, it is preferred to replace the liquid crystalline atmosphere with at least one gas of dry air and an inert gas (preferably nitrogen gas or argon gas), and then transfer the composition for gel electrolyte into the other container for storage.

To inhibit mixing of dust particles and the like into the composition for gel electrolyte, it is preferred to perform each of the steps for purifying the composition for gel electrolyte solution in a clean room with a high cleanliness level. At least the step of contacting the raw materials or the composition for gel electrolyte solution with an adsorbent and the step of drying may be performed, for example, in a clean room with a Class 1,000 cleanliness rating or lower. That is, each of the steps may be performed, for example, in a Class 1,000 clean room or a clean room with a cleanliness level higher than Class 1,000. in a Class 1,000 clean room, the number of dust particles with a size of 0.5 μm or more contained per cubic foot is 1,000 or less.

To inhibit deterioration of the composition for gel electrolyte due to ultraviolet rays, each of the steps for purifying the composition for gel electrolyte is preferably performed in an environment having a low UV intensity. At least the step of contacting the raw materials or the composition for gel electrolyte solution with an adsorbent and the step of drying may be performed, for example, in an environment having a UV intensity of 0.1 mW/cm² or less.

In each of the steps of purifying the raw materials or the composition for gel electrolyte, a device whose contact surface is coated with a fluororesin and/or a silicone resin may be used as a device (contact device) to he brought into contact with one or more of the raw materials and the composition for gel electrolyte, to facilitate maintenance of the device.

Examples of the contact device include a syringe and a dispensing spoon used for collecting the raw materials; a container that contains the composition for gel electrolyte during weighing; a container that contains the raw materials in the washing step; a container that contains the composition for gel electrolyte in the step of contacting it with an adsorbent; a container that contains the composition for gel electrolyte in the drying step; and a stirrer used for stirring. Furthermore, after a certain step is completed, and before the subsequent step is performed, if the composition for gel electrolyte or the like is transferred from a predetermined container into another through a pipe, the pipe is also defined as a contact device. For example, if the mixture is transferred through a pipe from a container that contains the composition for gel electrolyte into a container that contains the composition for gel electrolyte in the step of contacting it with an adsorbent, the pipe is also defined as a contact device.

Of course, not all contact devices need to have a coating surface coated with a fluororesin and/or a silicone resin; however, if they are coated, the above-described advantage can be achieved.

The polyether copolymer having an ethylene oxide unit is a copolymer having a repeating unit of ethylene oxide (an ethylene oxide unit) represented by Formula (B) shown below in the main chain or a side chain thereof.

CH₂—CH₂—O (B)

The polyether copolymer preferably has a repeating unit represented by Formula (C):

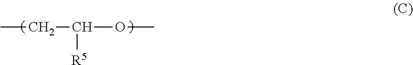

wherein R⁵ is a group having an ethylenically unsaturated group, and the number of carbon atoms in the ethylenically unsaturated group is typically about 2 to 13.

The polyether copolymer may also contain a repeating unit represented by Formula (A):

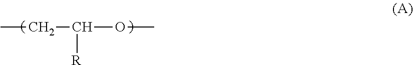

wherein R is a C₁₋₁₂ alkyl group or a —CH₂O(CR¹R²R³) group; R¹, R², and R³ are each independently a hydrogen atom or a —CH₂O(CH₂CH₂O)ₙR⁴ group; R⁴ is a C₁₋₁₂ alkyl group or an aryl group optionally having a substituent, wherein examples of the aryl group include a phenyl group; and n is an integer from 0 to 12.

In the polyether copolymer, the molar proportions of the repeating units (A), (B), and (C) are preferably (A): 0 to 89.9 mol %, (B): 99 to 10 mol %, and (C): 0.1 to 15 mol %, more preferably (A): 0 to 69.9 mol %, (B): 98 to 30 mol %, and (C): 0.1 to 13 mol %, and still more preferably (A): 0 to 49.9 mol %, (B): 98 to 50 mol %, and (C): 0.1 to 11 mol %.

In the polyether copolymer, if the molar proportion of the repeating unit (B) is over 99 mol %, an increase in glass transition temperature and crystallization of the oxyethylene chain may be invited, possibly causing a significant decrease in the ionic conductivity of the gel electrolyte after curing. It is commonly known that the ionic conductivity is improved by reducing the crystallinity of polyethylene oxide. In this respect, the polyether copolymer of the present invention is markedly advantageous.

The polyether copolymer may be any type of copolymer, for example, a block copolymer or a random copolymer. Among these copolymers, a random copolymer is preferred in that it is highly effective in reducing the crystallinity of polyethylene oxide.

The polyether copolymer having the repeating units (ethylene oxide units) of Formulas (A), (B), and (C) shown above can be suitably obtained by polymerizing monomers represented by Formulas (1), (2), and (3) shown below. Moreover, the polymer obtained by polymerizing these monomers may be cross-linked.

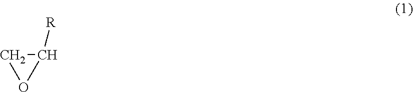

wherein R is a C₁₋₁₂ alkyl group or a —CH₂O(CR¹R²R³) group; R¹, R², and R³ are each independently a hydrogen atom or a —CH₂O(CH₂CH₂O)ₙR⁴ group; R⁴ is a C₁₋₁₂ alkyl group or an aryl group optionally having a substituent, wherein examples of the aryl group include a phenyl group; and n is an integer from 0 to 12.

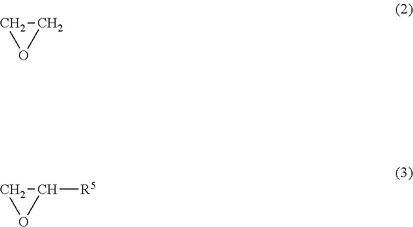

wherein R⁵ is a group having an ethylenically unsaturated group, and the number of carbon atoms in the ethylenically unsaturated group is typically about 2 to 13.

The compound represented by Formula (1) above is commercially available, or can be readily synthesized using a common ether synthesis method from epihalohydrin and an alcohol. Examples of commercially available compounds that can be used include propylene oxide, butylene oxide, methyl glycidyl ether, ethyl glycidyl ether, butyl glycidyl ether, t-butyl glycidyl ether, benzyl glycidyl ether, 1,2-epoxydodecane, 1,2-epoxyoctane, 1,2-epoxyheptane, 2-ethylhexyl glycidyl ether, 1,2-epoxydecane, 1,2-epoxyhexane, glycidyl phenyl ether, 1,2-epoxypentane, and glycidyl isopropyl ether. Among these commercially available products, propylene oxide, butylene oxide, methyl glycidyl ether, ethyl glycidyl ether, butyl glycidyl ether, and glycidyl isopropyl ether are preferred; and propylene oxide, butylene oxide, methyl glycidyl ether, and ethyl glycidyl ether are particularly preferred.

In the monomer represented by Formula (1) obtained by synthesis, R is preferably —CH₂O(CR¹R²R³), and at least one of R¹, R², and R³ is preferably —CH₂O(CH₂CH₂O)ₙR⁴; R⁴ is preferably a C₁₋₆ alkyl group, and more preferably a C₁₋₄ alkyl group; and n is preferably 2 to 6, and more preferably 2 to 4.

The compound of Formula (2) is a basic chemical product, and is readily commercially available.

In the compound of Formula (3), R⁵ is a substituent containing an ethylenically unsaturated group. Specific examples of the compound represented by Formula (3) above include allyl glycidyl ether, 4-vinylcyclohexyl glycidyl ether, α-terpinyl glycidyl ether, cyclohexenylmethyl glycidyl ether, p-vinylbenzyl glycidyl ether, allylphenyl glycidyl ether, vinyl glycidyl ether, 3,4-epoxy-1-butene, 4,5-epoxy-1-pentene, 4,5-epoxy-2-pentene, glycidyl acrylate, glycidyl methacrylate, glycidyl sorbate, glycidyl cinnamate, glycidyl crotonate, and glycidyl 4-hexenoate. Allyl glycidyl ether, glycidyl acrylate, and glycidyl methacrylate are preferred.

The repeating units (A) and (C) may each be derived from two or more different monomers.

The polyether copolymer can be synthesized as follows, for example: Using, as a ring-opening polymerization catalyst, an organoaluminum-based catalyst system or an organozinc-based catalyst system, a coordinated anionic polymerization initiator such as an organotin-phosphate ester condensate catalyst system, or an anionic polymerization initiator such as a potassium alkoxide, diphenylmethylpotassium, or potassium hydroxide containing K⁺ as a counter ion, the monomers are reacted with stirring at a reaction temperature of 10 to 120° C. with or without solvent to produce the polyether copolymer. Coordinated anionic polymerization initiators are preferred in view of the polymerization degree and the properties of the resulting copolymer, and an organotin-phosphate ester condensate catalyst system is particularly preferred because of its handleability.

The weight-average molecular weight of the polyether copolymer is, for example, preferably about 10,000 to 2,500,000, more preferably about 50,000 to 2,000,000, and still more preferably about 100,000 to 1,800,000, in order to achieve favorable processability, mechanical strength, and flexibility.

Furthermore, from the viewpoint of improving the coatability, gelation properties, and liquid retention properties of the composition for gel electrolyte, as well as increasing the film strength after gelation of the composition for gel electrolyte, and imparting excellent power characteristics and a high capacity retention ratio to an electrochemical capacitor, the molecular weight distribution of the polyether copolymer is preferably 3.0 to 10.0, and more preferably 4.0 to 8.0. The molecular weight distribution is determined by calculating the weight-average molecular weight and the number average molecular weight by GPC measurement relative to polystyrene standards, and determining the weight-average molecular weight/number average molecular weight ratio.

In the present invention, the weight-average molecular weight is measured by gel permeation chromatography (GPC) relative to polystyrene standards.

From the viewpoint of adjusting the water content in the composition for gel electrolyte of the present invention to 50 ppm or less, the water content in the polyether copolymer is preferably 200 ppm or less, more preferably 150 ppm or less, and particularly preferably 100 ppm or less.

In the composition for gel electrolyte of the present invention, the solid concentration of the polyether copolymer is preferably about 5 to 20% by mass based on the total solid content of the composition for gel electrolyte.

The electrolyte salt contained in the composition for gel electrolyte of the present invention preferably comprises an ambient temperature molten salt (ionic liquid).

In the present invention, an ambient temperature molten salt used as the electrolyte salt can also exert the effects of a common organic solvent upon the gel electrolyte after curing.

The “ambient temperature molten salt” refers to a salt that is at least partially liquid at ambient temperature, wherein the “ambient temperature” refers to the range of temperatures where a power supply is generally assumed to operate. The range of temperatures where a power supply is generally assumed to operate is in the range where the upper limit is about 120° C., potentially about 60° C., and the lower limit is about −40° C., potentially about −20° C. Such ambient temperature molten salts may be used alone or in combination of two or more.

Ambient temperature molten salts are also referred to as ionic liquids. As cations of ambient temperature molten salts, pyridine-based, aliphatic amine-based, or alicyclic amine-based organic quaternary ammonium cations are known. Examples of such organic quaternary ammonium cations include imidazolium ions such as dialkylimidazolium ions and trialkylimidazolium ions, tetraalkylammonium ions, alkylpyridinium ions, pyrazolium ion, pyrrolidinium ion, and piperidinium ion. In particular, imidazolium cations are preferred.

Examples of imidazolium cations include dialkylimidazolium ions and trialkylimidazolium ions. Examples of dialkylimidazolium ions include, although not limited to, 1,3-dimethylimidazolium ion, 1-ethyl-3-methylimidazolium 1-methyl-3-ethylimidazolium ion, 1-methyl-3-butylimidazolium ion, and 1-butyl-3-methylimidazolium ion. Examples of trialkylimidazolium ions include, although not limited to, 1,2,3-trimethylimidazolium ion, 1,2-dimethyl-3-ethylimidazolium ion, 1,2-dimethyl-3-propylimidazolium ion, and 1-butyl-2,3-dimethylimidazolium ion. Moreover, 1-allylimidazolium ions such as 1-allyl-3-ethylimidazolium ion, 1-allyl-3-butylimidazolium ion, and 1,3-diallylimidazolium ion can be used.

Examples of tetraalkylammonium ions include, although not limited to, trimethylethylammonium ion, dimethyldiethylammonium ion, trimethylpropylammonium ion, trimethylhexylammonium ion, tetrapentylammonium ion, and N,N-diethyl-N-methyl-N-(2-methoxyethyl)ammonium ion.

Examples of alkylpyridinium ions include, although not limited to, N-methylpyridinium ion, N-ethylpyridinium ion, N-propylpyridinium N-butylpyridinium ion, 1-ethyl-2-methylpyridinium ion, 1-butyl-4-methylpyridinium ion, 1-butyl-2,4-dimethylpyridinium ion, and N-methyl-N-propylpiperidinium ion.

Examples of pyrrolidinium ions include, although not limited to, N-(2-methoxyethyl)-N-methylpyrrolidinium ion, N-ethyl-N-methylpyrrolidinium ion, N-ethyl-N-propylpyrrolidinium ion, N-methyl-N-propylpyrrolidinium ion, and N-methyl-N-butylpyrrolidinium ion.

Examples of counter anions include inorganic acid ions, for example, halide ions such as chloride ion, bromide ion, and iodide ion, perchlorate ion, thiocyanate ion, tetrafluoroborate ion, nitrate ion, AsF₆⁻, and PF₆⁻; and organic acid ions such as trifluoromethanesulfonate ion, stearylsulfonate ion, octylsulfonate ion, dodecylbenzenesulfonate ion, naphthalenesulfonate ion, dodecylnaphthalenesulfonate ion, 7,7,8,8-tetracyano-p-quinodimethane ion, bis(trifluoromethanesulfonyl)imide ion, bis(fluorosulfonyl)imide ion, tris(trifluoromethylsulfonyl)methide ion, bis(pentafluoroethylsulfonyl)imide ion, 4,4,5,5-tetraflouro-1,3,2-dithiazolidine-1,1,3,3-tetraoxide ion, trifluoro(pentafluoroethyeborate ion, and trifluoro-tris(pentafluoroethyl)phosphate ion.

The composition for gel electrolyte of the present invention may contain the following electrolyte salts: for example, compounds each composed of a cation selected from metal cations, ammonium ion, amidinium ion, and guanidinium ion; and an anion selected from chloride ion, bromide ion, iodide ion, perchlorate ion, thiocyanate ion, tetrafluoroborate ion, nitrate ion, AsF₆⁻, PF₆⁻, stearylsulfonate ion, octylsulfonate ion, dodecylbenzenesulfonate ion, naphthalenesulfonate ion, dodecylnaphthalenesulfonate ion, 7,7,8,8-tetracyano-p-quinodimethane ion, X¹SO₃⁻, [(X¹SO₂)(X²SO₂)N]⁻, [(X¹SO₂)(X²SO₂)(X³SO₂)C]⁻, and [(X¹SO₂)(X²SO₂)YC]⁻, wherein X¹, X², X³, and Y are each an electron-withdrawing group; preferably, X₁, X₂, and X₃ are each independently a C₁₋₆ perfluoroalkyl group or a C₆₋₁₈ perfluoroaryl group, Y is a nitro group, a nitroso group, a carbonyl group, a carboxyl group, or a cyano group, and X¹, X², and X³ may each be the same or different.

Cations of transition metals may be used as metal cations, Preferably, the cation of a metal selected from Mn, Fe, Co, Ni, Cu, Zn, and Ag is used. A favorable result can also be obtained using the cation of a metal selected from Li, Na, K, Rb, Cs, Mg, Ca, and Ba. The above-mentioned compounds can be used in combination of two or more as the electrolyte salt. In particular, in a lithium-ion capacitor, a lithium salt compound is suitably used as the electrolyte salt, in the present invention, the electrolyte salt preferably includes a lithium salt compound.

As the lithium salt compound, a lithium salt compound having a wide potential window, such as one commonly used in a lithium-ion capacitor, is used. Examples of such lithium salt compounds include, although not limited to, LiBF₄, LiPF₆, LiClO₄, LiCF₃SO₃, LiN(CF₃SO₂)₂, LiN(C₂F₅SO₂)₂, and LiN[CF₃SC(C₂F₅SO₂)₃]₂. These lithium salt compounds may be used alone or as a mixture of two or more.

In the composition for gel electrolyte of the present invention, the electrolyte salt is preferably miscible in the above-described polyether copolymer, a cross-linked product of the copolymer, or a mixture containing the polyether copolymer and/or the cross-linked product of the copolymer, and the electrolyte salt. As used herein, “miscible” refers to the state in which the electrolyte salt does not form a precipitate due to crystallization, for example.

In the present invention, in the case of a lithium-ion capacitor, for example, a lithium salt compound and an ambient temperature molten salt are preferably used as the electrolyte salt. In the case of an electric double-layer capacitor, an ambient temperature molten salt only is preferably used as the electrolyte salt.

In the present invention, in the case of a lithium-ion capacitor, the amount of the electrolyte salt to be used (the total amount of the lithium salt compound and the ambient temperature molten salt to be used) based on the amount of the polyether copolymer is such that the amount of the electrolyte salt is preferably 1 to 120 parts by mass, and more preferably 3 to 90 parts by mass, per 10 parts by mass of the polyether copolymer. In the case of an electric double-layer capacitor, the amount of the ambient temperature molten salt to be used is preferably 1 to 300 parts by mass, and more preferably 5 to 200 parts by mass, per 10 parts by mass of the polyether copolymer.

From the viewpoint of adjusting the water content in the composition for gel electrolyte of the present invention to 50 ppm or less, the water content in the electrolyte salt is preferably 30 ppm or less, more preferably 20 ppm or less, and particularly preferably 15 ppm or less.

The composition for gel electrolyte of the present invention preferably contains a photoreaction initiator, and further contains a cross-linking aid, as required, from the viewpoint of achieving a gel electrolyte having a high film strength by curing.

An alkylphenone-based photoreaction initiator is suitably used as the photoreaction initiator. An alkylphenone-based photoreaction initiator is very preferable in that it allows the reaction to proceed rapidly, and is unlikely to contaminate the composition for gel electrolyte.

Specific examples of the alkylphenone-based photoreaction initiator include hydroxyalkylphenone-based compounds such as 1-hydroxy-cyclohexyl-phenyl-ketone, 2-hydroxy-2-methyl-1-phenyl-propan-1 -one, 1-[4-(2-hydroxyethoxy)-phenyl]-2-hydroxy-2-methyl-1-propan-1-one, 2-hydroxy-1-[4-[4-(2-hydroxy-2-methyl-propionyl)-benzyl]phenyl]-2-methyl -propan-1-one, and 2,2-dimethoxy-1,2-diphenylethan-1-one; and aminoalkylphenone-based compounds such as 2-methyl-1-(4-methylthiophenyl)-2-morpholinopropan-1-one, 2-(dimethylamino)-2-[(4-methylphenyl)methyl]-1-1-[4-(4-morpholinyl)phenyl]-1-buta-none, and 2-benzyl-2-dimethylamino-1 -(4-morpholinophenyl)-butanone-1. Other specific examples include 2,2-dimethoxy-1,2-diphenylethan-1-one and phenylglyoxylic acid methyl ester. Among the above, 2-hydroxy-2-methyl-1-phenyl-propan-1-one, 1-[4-(2-hydroxyethoxy)-phenyl]-2-hydroxy-2-methyl-1-propan-1-one, 2-benzyl-2-dimethylamino-1-(4-morpholinophenyl)-butanone-1, and 2-(dimethylamino)-2-[(4-methylphenyl)methyl]-1-[4-(4-morpholinyl)phenyl]-1-buta-none are preferred.

Furthermore, a mixture of a hydroxyalkylphenone-based compound and an aminoalkylphenone-based compound allows the surface and the inside of the composition for gel electrolyte to be effectively polymerized over a wide range of wavelengths, and allows the gel strength to be increased.

Examples of other photoreaction initiators include benzophenone-based, acylphosphine oxide-based, titanocene-based, triazine-based, bisimidazole-based, and oxime ester-based initiators. Each of these photoreaction initiators may be used alone, or may be added as an auxiliary initiator with an alkylphenone-based photoreaction initiator.

While the amount of the photoreaction initiator to be used for the cross-linking reaction is not particularly limited, it is preferably about 0.1 to 10 parts by mass, and more preferably about 0.1 to 4.0 parts by mass, per 100 parts by mass of the polyether copolymer.

In the present invention, a cross-linking aid may be used in combination with a photoreaction initiator. The cross-linking aid is typically a polyfunctional compound (for example, a compound having at least two units of CH₂═CH—, CH₂═CH—CH₂—, or CF₂═CF—). Specific examples of the cross-linking aid include triallyl cyanurate, triallyl isocyanurate, triacrylformal, triallyl trimellitate, N,N′-m-phenylene bismaleimide, dipropargyl terephthalate, diallyl phthalate, tetraallyl terephthalamide, triallyl phosphate, hexafluorotriallyl isocyanurate, N-methyltetrafluorodiallyl isocyanurate, trimethylolproparte trimethacrylate, trimethylolpropane triacrylate, ethoxylated isocyanuric acid triacrylate, pentaerythritol triacrylate, ditrimethyloipropane tetraacrylate, polyethylene glycol diacrylate, and ethoxylated bisphenol A diacrylate.

In the present invention, an aprotic organic solvent may be added to the composition for gel electrolyte. When the composition for gel electrolyte of the present invention is combined with an aprotic organic solvent, for example, the viscosity can be adjusted during the preparation of a capacitor, and the performance of a capacitor can be adjusted.

Preferred as the aprotic organic solvent are aprotic nitriles, ethers, and esters. Specifically, examples of the aprotic organic solvent include acetonitrile, propylene carbonate, γ-butyrolactone, butylene carbonate, vinyl carbonate, ethylene carbonate, dimethyl carbonate, ethyl methyl carbonate, diethyl carbonate, methyl monoglyme, methyl diglyme, methyl triglyme, methyl tetraglyme, ethyl monoglyme, ethyl diglyme, ethyl triglyme, ethyl methyl monoglyme, butyl diglyme, 3-methyl-2-oxazolidone, tetrahydrofuran, 2-methyltetrahydrofuran, 1,3-dioxolane, 4,4-methyl-1,3-dioxolane, methyl formate, methyl acetate, and methyl propionate. Among the above, propylene carbonate, γ-butyrolactone, butylene carbonate, vinyl carbonate, ethylene carbonate, methyl triglyme, methyl tetraglyme, ethyl triglyme, and ethyl methyl monoglyme are preferred. A mixture of two or more of these solvents may be used.

The composition for gel electrolyte of the present invention may contain at least one material selected from the group consisting of inorganic particles, resin particles, and microfibers made of resins, for the purpose of imparting a certain strength to the gel electrolyte after curing, or further increasing the ion permeability. These materials may be used alone or in combination of two or more.

The inorganic particles may be any inorganic particles that are electrochemically stable and electrically insulating. Examples of such inorganic particles include particles of inorganic oxides such as iron oxides (FeₓO_{y} such as FeO and Fe₂O₃), SiO₂, Al₂O₃, TiO₂, BaTiO₂, and ZrO₂; particles of inorganic nitrides such as aluminum nitride and silicon nitride; particles of poorly soluble ionic crystals such as calcium fluoride, barium fluoride, barium sulfate, and calcium carbide; particles of covalent crystals such as silicon and diamond; and particles of clays such as montmorillonite. The particles of inorganic oxides may he particles of mineral resource-derived materials such as boehmite, zeolite, apatite, kaolin, mullite, spinel, olivine, and mica, as well as artificial products thereof. The inorganic particles may also be particles provided with electrical insulating properties obtained by coating the surface of conductive materials including metals, conductive oxides such as SnO₂ and indium tin oxide (ITO), and carbonaceous materials such as carbon black and graphite, with materials having electrically insulating properties (such as the above-described inorganic oxides).

The resin particles are preferably particles composed of materials that have heat resistance and electrically insulating properties, are stable to ambient temperature molten salts and the like, and are redox-resistant in the range of operating voltages of the capacitor and are electrochemically stable. Examples of such materials include cross-linked products of resins. Specific examples of such materials include a cross-linked product of at least one resin selected from the group consisting of styrene resins [such as polystyrene (PS)], styrene-butadiene rubber (SBR), acrylic resins [such as polymethylmethacrylate (PMMA)1, polyalkyleneoxides [such as polyethylene oxide (PEO)], fluororesins [such as polyvinylidene fluoride (PVDF)], and derivatives thereof; urea resin; and polyurethane. The above-mentioned resins may be used alone or in combination of two or more as the resin particles. The organic particles may also contain, as required, various known additives that may be added to resins, such as an antioxidant.

Examples of the microfibers made of resins include microfibers composed of resins such as polyimide, polyacrylonitrile, aramid, polypropylene (PP), chlorinated PP, PEO, polyethylene (PE), cellulose, cellulose derivatives, polysulfone, polyethersulfone, polyvinylidene fluoride (PVDF), and vinylidene fluoride-hexafluoropropylene copolymer, as well as derivatives thereof.

Among the above-mentioned inorganic particles, resin particles, and microfibers made of resins, particles of Al₂O₃, SiO₂, boehmite, or PMMA (cross-linked PMMA) are particularly preferably used.

The inorganic particles and the resin particles may have any shapes, such as a spherical shape, a flat shape, and a polyhedral shape other than the flat shape.

The composition for gel electrolyte of the present invention may be produced by mixing the electrolyte salt, the polyether copolymer, and components that are optionally added. Examples of methods for mixing the electrolyte salt and the polyether copolymer include, although not particularly limited to, a method that involves immersing the polyether copolymer in a solution containing the electrolyte salt for a long time to impregnate the polyether copolymer with the electrolyte salt; a method that involves mechanically mixing the electrolyte salt into the polyether copolymer; a method that involves dissolving the polyether copolymer in art ambient temperature molten salt; and a method that involves mixing the polyether copolymer with the electrolyte salt after dissolving the polyether copolymer in another solvent. When the composition for gel electrolyte of the present invention is produced using the other solvent, various polar solvents such as tetrahydrofuran, acetone, acetonitrile, dimethylformamide, dimethylsulfoxide, dioxane, methyl ethyl ketone, and methyl isobutyl ketone may be used alone or in combination as the other solvent. When the polyether copolymer is to be cross-linked, the other solvent may be removed before, during, or after cross-linking.

The method for producing the composition for gel electrolyte of the present invention may include at least one of the above-described methods for reducing the water content in components forming the composition such as the polyether copolymer and the electrolyte salt.

A gel electrolyte is obtained by curing (i.e., gelling) the composition for gel electrolyte of the present invention. For example, the composition for gel electrolyte containing a photoreaction initiator may be gelled by cross-linking the polyether copolymer by irradiating the composition for gel electrolyte with active energy rays such as ultraviolet rays. A gel electrolyte may also be prepared by impregnating the cross-linked polyether copolymer with the electrolyte salt. In the present invention, because this gel electrolyte is used as an electrolyte for an electrochemical capacitor, a special separator is not required, and the gel electrolyte can serve both as an electrolyte and a separator. To maintain a non-fluid state that does not require a separator, the viscosity of the gel electrolyte may be 8 Pa·s or more in the use environment of the battery.

Examples of active energy rays usable for photo-induced cross-linking include ultraviolet rays, visible rays, and electron beams. Ultraviolet rays are particularly preferred because they are inexpensive and easy to control.

In the case of using ultraviolet rays, the cross-linking reaction may be performed by, for example, irradiating the electrolyte with a wavelength of 365 nm at an intensity of 1 to 50 mW/cm² for 0.1 to 30 minutes, using a xenon lamp, a mercury lamp, a high-pressure mercury lamp, or a metal halide lamp.

In an electrochemical capacitor, the thickness of the gel electrolyte layer formed by curing the composition for gel electrolyte is advantageously smaller to increase the capacity of the electrochemical capacitor. Thus, the thickness of the gel electrolyte layer is preferably as small as possible, although an appropriate thickness is required because an excessively small thickness may cause short circuits between the electrodes. The thickness of the gel electrolyte layer is, for example, preferably about 1 to 50 μm, more preferably about 3 to 30 μm, and still more preferably about 5 to 20 μm.

2. Electrochemical Capacitor

The electrochemical capacitor of the present invention comprises, between a cathode and an anode, a gel electrolyte layer comprising a cured product of the composition for gel electrolyte of the present invention described in detail in the “1. Composition for gel electrolyte” section above. Details of the composition for gel electrolyte of the present invention are as described above. The electrochemical capacitor of the present invention will be hereinafter described.

In the electrochemical capacitor of the present invention, each of the electrodes (i.e., the cathode and the anode) is obtained by forming an electrode composition containing an active material, a conductive additive, and a binder on a current collector as an electrode substrate. The current collector serves as an electrode substrate. The conductive additive serves to aid in favorable transfer of ions with the cathode or anode active material, and the gel electrolyte layer. The binder serves to fix the cathode or anode active material to the current collector.

Specific examples of methods for producing an electrode include a method that involves laminating, onto a current collector, an electrode composition that has been molded into a sheet (sheet molding method by kneading); a method that involves applying a pasty electrode composition for an electrochemical capacitor onto a current collector, followed by drying (wet molding method); and a method that involves preparing composite particles for an electrode composition for an electrochemical capacitor, molding the composite particles into a sheet on a current collector, and pressing the sheet with a roller press machine (dry molding method). Among these methods, the wet molding method or the dry molding method is preferred as the method for producing an electrode, and the wet molding method is more preferred.

As the material of a current collector, materials such as metals, carbon, and conductive polymers may be used, and a metal is preferably used. As the metal for a current collector, typically, metals such as aluminum, platinum, nickel, tantalum, titanium, stainless steel, copper, and other alloys are used. As a current collector for use with an electrode for a lithium-ion capacitor, copper, aluminum, or an aluminum alloy is preferably used in view of its conductivity and voltage resistance.

Examples of shapes of a current collector include current collectors that are made of metal foil, metal edge foil, and the like; and current collectors having through-holes that are made of expanded metal, punched metal, and meshes. A current collector having through-holes is preferred because it can reduce the diffusion resistance of electrolyte ions, and improve the power density of an electrochemical capacitor. In particular, expanded metal or punched metal is preferred because they achieve a superior electrode strength.

The proportion of holes in a current collector is, for example, preferably about 10 to 80% by area, more preferably about 20 to 60% by area, and still more preferably about 30 to 50% by area, although not particularly limited thereto. When the proportion of through-holes is in this range, the diffusion resistance of the electrolytic solution decreases, and the internal resistance of a lithium-ion capacitor decreases.

The thickness of a current collector is, for example, preferably about 5 to 100 μm, more preferably about 10 to 70 μm, and particularly preferably about 20 to 50 μm, although not particularly limited thereto.

In the electrochemical capacitor of the present invention, specifically, allotropes of carbon are typically used as the electrode active material for the cathode, and a wide range of electrode active materials used for electric double-layer capacitors can be used. Specific examples of allotropes of carbon include activated carbon, polyacenes (PAS), carbon whiskers, and graphite. Powders or fibers of these materials may be used. In particular, activated carbon is preferred. Specific examples of activated carbon include activated carbon obtained from raw materials such as phenolic resins, rayon, acrylonitrile resins, pitch, and coconut shell. When these allotropes of carbon are used in combination, two or more allotropes of carbon having different average particle diameters or particle size distributions may be used in combination. Besides the above-described materials, a polyacene organic semiconductor (PAS), which is a heat-treated product of an aromatic condensation polymer, and has a polyacene skeleton structure wherein the atomic ratio of hydrogen atoms/carbon atoms is 0.50 to 0.05, can be suitably used as the electrode active material for the cathode.

The electrode active material for the anode may be any material that can reversibly carry cations. Specifically, a wide range of electrode active materials used for anodes of lithium-ion secondary batteries can be used. Particularly preferred are crystalline carbon materials such as graphite and non-graphitizable carbon, carbon materials such as hard carbon, coke, activated carbon, and graphite, and the polyacene materials (PAS) described above as the electrode active material for the cathode. As each of these carbon materials and PAS, a product is used that is obtained by carbonizing a phenolic resin or the like, activating the carbonized product, as required, and grinding the resulting product.

The electrode active material is preferably formed into a particulate shape. When the particles have a spherical shape, an electrode with a higher density can be formed at the time of molding the electrode.

For both the cathode and the anode, the volume average particle diameter of the electrode active materials is typically 0.1 to 100 μm, preferably 0.5 to 50 μm, and more preferably 1 to 20 μm. ‘These electrode active materials may be used alone or in combination of two or more.

Examples of the conductive additive include particulate or fibrous conductive additives, such as conductive carbon blacks such as graphite, furnace black, acetylene black, and Ketjenblack (registered trademark of Akzo Nobel Chemicals B.V.), and carbon fibers. Among the above, acetylene black and furnace black are preferred.

The conductive additive preferably has a volume average particle diameter smaller than that of the electrode active materials, and typically has a volume average particle diameter of about 0.001 to 10 μm, preferably about 0.005 to 5 μm, and more preferably about 0.01 to 1 μm, for example. When the volume average particle diameter of the conductive additive is in this range, a higher conductivity can be achieved using a smaller amount of the conductive additive. These conductive additives may he used alone or in combination of two or more. The amount of the conductive additive to be contained in an electrode is, for example, preferably about 0.1 to 50 parts by mass, more preferably about 0.5 to 15 parts by mass, and still more preferably about 1 to 10 parts by mass, per 100 parts by mass of the electrode active material. When the amount of the conductive additive is in this range, the capacity of the electrochemical capacitor can be increased, and the internal resistance of the electrochemical capacitor can be reduced.

Examples of usable binders include, although not limited to, nonaqueous binders such as polytetrafluoroethylene (PTFE), polyvinylidene fluoride (PVdF), fluororubber, and styrene-butadiene rubber (SBR); and aqueous binders such as acrylic rubber.

The binder preferably has a glass transition temperature (Tg) of 50° C. or lower, and more preferably −40 to 0° C. When the glass transition temperature (Tg) of the binder is in this range, a small amount of the binder may be used to achieve excellent binding properties, a high electrode strength, and high flexibility, and allow the electrode density to be readily increased by the pressing step during the formation of an electrode.

The number average particle diameter of the binder is typically about (10001 to 100 μm, preferably about 0.001 to 10 μm, and still more preferably about 0.01 to 1 μm, for example, although not particularly limited thereto. When the number average particle diameter of the binder is in this range, a high binding force can be imparted to a polarizable electrode, using a small amount of the binder. As used herein, the “number average particle diameter” refers to the number average particle diameter determined by measuring diameters of 100 particles of the binder that are randomly selected in a transmission electron micrograph, and calculating the arithmetic mean value of these diameters. The particles may have either a spherical or irregular shape. These binders may be used alone or in combination of two or more.

The amount of the binder to be contained is typically about 0.1 to 50 parts by mass, preferably about 0.5 to 20 parts by mass, and more preferably about 1 to 10 parts by mass, for example, per 100 parts by mass of the electrode active material. When the amount of the binder is in this range, sufficient adhesion between the resulting electrode composition layer and a current collector can be ensured, which allows the capacity of the electrochemical capacitor to be increased, and the internal resistance of the electrochemical capacitor to be reduced.

In the present invention, each of the cathode and the anode is preferably prepared as follows: Slurry formed by adding the above-described cathode or anode active material, conductive additive, and binder into a solvent is applied onto a current collector sheet and dried. Subsequently, the electrode is pressure-bonded at a pressure of 0 to 5 ton/cm², and particularly 0 to 2 ton/cm², and then fired at 200° C. or higher, preferably at 250 to 500° C., and more preferably at 250 to 450° C., for 0.5 to 20 hours, and particularly 1 to 10 hours.

In the electrochemical capacitor of the present invention, the cathode and/or the anode may be doped in advance, i.e., intercalated, with lithium ions. The means for doping the cathode and/or the anode is not particularly limited. For example, the doping may he accomplished electrochemically, or by physically contacting the cathode or anode with a lithium-ion source.

Examples of methods for producing the electrochemical capacitor of the present invention include a method for producing the electrochemical capacitor of the present invention comprising the steps of placing the composition for gel electrolyte of the present invention between a cathode and an anode; and curing the composition for gel electrolyte kept in this state to form a gel electrolyte.

Examples of methods for producing the electrochemical capacitor of the present invention also include a method for producing the electrochemical capacitor of the present invention comprising the steps of applying the composition for gel electrolyte of the present invention to a surface of at least one of a cathode and an anode; forming a gel electrolyte layer by irradiating the composition for gel electrolyte with active energy rays to cure the composition for gel electrolyte; and laminating the cathode and the anode with the gel electrolyte layer sandwiched therebetween.

The composition for gel electrolyte may he cured (cross-linked) by irradiating the composition with active energy rays, with or without an aprotic organic solvent. Specific examples of active energy rays are as described above.

As described above, in the electrochemical capacitor of the present invention, the gel electrolyte layer can serve both as an electrolyte and a separator. That is, the gel electrolyte layer can be used as a separator.

Furthermore, in the present invention, an electrochemical capacitor may be produced by curing the composition for gel electrolyte of the present invention to form an electrolyte film, and laminating the electrolyte film on an electrode. The electrolyte film can he obtained by applying the composition for gel electrolyte to a release sheet, for example, curing the composition on the release sheet, and releasing the composition from the release sheet.

The electrochemical capacitor of the present invention has excellent power characteristics and a high capacity retention ratio, and thus, can be used in a range of applications from small capacitors for mobile phones and laptop computers to stationary and in-vehicle large capacitors.

### EXAMPLES

The present invention will be hereinafter described in detail with examples and comparative examples, although the present invention is not limited to the examples. The water content was measured using the Karl Fischer method.

### SYNTHESIS EXAMPLE

### Production of Catalyst for Polymerization of Polyether Copolymer

A three-necked flask equipped with a stirrer, a thermometer, and a distillation device was charged with 10 g of tributyltin chloride and 35 g of tributyl phosphate. The mixture was heated at 250° C. for 20 minutes while stirring under a nitrogen stream to distill off the distillate, thereby giving a solid condensate as a residue. This product was used as a polymerization catalyst in each of the polymerization examples given below.

In the following examples, the composition in terms of monomers of a polyether copolymer was determined using ¹H NMR spectroscopy. The molecular weight of the polyether copolymer was measured by gel permeation chromatography (GPC), and the weight-average molecular weight was calculated relative to polystyrene standards. The GPC measurement was performed at 60° C., using RID-6A from Shimadzu Corporation, Shodex columns KD-807, KD-806, KD-806M, and KD-803 from Showa Denko K.K., and DMF as the solvent.

### Polymerization Example 11

The atmosphere in a 3-L four-necked glass flask was replaced with nitrogen, and the flask was charged with 1 g of the condensate described in the synthesis example of the catalyst as a polymerization catalyst, as well as 158 g of the below-shown glycidyl ether compound (a) having a water content adjusted to 10 ppm or less, 22 g of allyl glycidyl ether, and 1,000 g of n-hexane as a solvent.

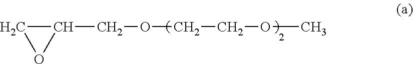

1.25 g of ethylene oxide was gradually added while monitoring the polymerization degree of the compound (a) by gas chromatography. The polymerization temperature was 20° C., and the reaction was performed for 10 hours. The polymerization reaction was terminated by adding 1 mL of methanol. The polymer was isolated by decantation. The resulting polymer was then dissolved in 300 g of THF, and the solution was added into 1,000 g of n-hexane. This procedure was repeated, the resulting product was filtered off, and then the filtrate was dried at 40° C. under normal pressure for 24 hours and additionally at 50° C. under reduced pressure for 15 hours to give 280 g of a polymer. Table 1 shows the weight-average molecular weight and the results of analysis of the composition in terms of monomers of the resulting polyether copolymer. The water content in the resulting polymer was 120 ppm.

### Polymerization Example 2

The atmosphere in a 3-L four-necked glass flask was replaced with nitrogen, and the flask was charged with 2 g of the condensate described in the synthesis example of the catalyst as a catalyst, as well as 40 g of glycidyl methacrylate having a water content adjusted to 10 ppm or less, 1,000 g of n-hexane as a solvent, and 0.07 g of ethylene glycol monomethyl ether as a chain transfer agent. 230 g of ethylene oxide was gradually added while monitoring the polymerization degree of glycidyl methacrylate by gas chromatography. The polymerization reaction was terminated with methanol. The polymer was isolated by decantation. The resulting polymer was then dissolved in 300 g of THF, and the solution was added into 1,500 g of n-hexane. This procedure was repeated twice, the resulting product was filtered off, and then the filtrate was dried at 40° C. under normal pressure for 24 hours and additionally at 50° C. under reduced pressure for 15 hours to give 238 g of a polymer. Table 1 shows the weight-average molecular weight and the results of analysis of the composition in terms of monomers of the resulting polyether copolymer. The water content in the resulting polymer was 98 ppm.

### Polymerization Example 3

223 g of a polymer was obtained following the same procedures as Polymerization Example 2, except that the flask was charged with 50 g of glycidyl methacrylate, 195 g of ethylene oxide, and 0.06 g of ethylene glycol monomethyl ether, and then polymerization was performed. Table 1 shows the weight-average molecular weight and the results of analysis of the composition in terms of monomers of the resulting polyether copolymer. The water content in the resulting polymer was 97 ppm.

### Polymerization Example 4

125 g of a polymer was obtained following the same procedures as Polymerization Example 2, except that the flask was charged with 30 g of allyl glycidyl ether, 100 g of ethylene oxide, and 0.02 g of n-butanol, and then polymerization was performed. Table 1 shows the weight-average molecular weight and the results of analysis of the composition in terms of monomers of the resulting polyether copolymer. The water content in the resulting polymer was 90 ppm.

### Polymerization Example 5

252 g of a polymer was obtained following the same procedures as Polymerization Example 2, except that the flask was charged with 30 g of glycidyl methacrylate, 260 g of ethylene oxide, and 0.08 g of ethylene glycol monomethyl ether, and then polymerization was performed. Table 1 shows the weight-average molecular weight and the results of analysis of the composition in terms of monomers of the resulting polyether copolymer. The water content in the resulting polymer was 95 ppm.

### Comparative Polymerization Example 1

The atmosphere in a 3-L four-necked glass flask was replaced with nitrogen, and the flask was charged with 1 g of the condensate described in the synthesis example of the catalyst as a polymerization catalyst, as well as 158 g of the glycidyl ether compound (a) having a water content adjusted to 10 ppm or less, 22 g of allyl glycidyl ether, and 1,000 g of n-hexane as a solvent. 125 g of ethylene oxide was gradually added while monitoring the polymerization degree of the compound (a) by gas chromatography. The polymerization temperature was 20° C., and the reaction was performed for 10 hours. The polymerization reaction was terminated by adding 1 mL of methanol. The polymer was isolated by decantation, and then dried at 40° C. under normal temperature for 24 hours and additionally at 45° C. under reduced pressure for 10 hours to give 283 g of a polymer. Table 1 shows the weight-average molecular weight and the results of analysis of the composition in terms of monomers of the resulting polyether copolymer. The water content in the resulting polymer was 240 ppm.

TABLE 1

| | | | | | | | Comparative |
|---|---|---|---|---|---|---|---|
| | | Polymerization | Polymerization | Polymerization | Polymerization | Polymerization | Polymerization |
| | | Example 1 | Example 2 | Example 3 | Example 4 | Example 5 | Example 1 |
| Composition | Ethylene | 72 | 95 | 93 | 90 | 97 | 72 |
| in terms of | Oxide | | | | | | |
| Monomers | Compound (a) | 23 | 0 | 0 | 0 | 0 | 23 |
| (mol %) | Allyl Glycidyl | 5 | 0 | 0 | 10 | 0 | 5 |
| | Ether | | | | | | |
| | Glycidyl | 0 | 5 | 7 | 0 | 3 | 0 |
| | Methacrylate | | | | | | |

| | | | | | | |
|---|---|---|---|---|---|---|
| Weight-average molecular | 1,000,000 | 520,000 | 430,000 | 180,000 | 450,000 | 980,000 |
| weight of Copolymer | | | | | | |

### Purification of Ionic Liquid 1

10 ml of 1-ethyl-3-methylimidazolium bis(fluorosulfonyl)imide, which is an ionic liquid composed of 1-ethyl-3-methylimidazolium_{—} cation and bis(fluorosulfonium)imide anion, was washed with hexane and ethyl acetate at a ratio of 5:1. 10 ml of the washed ionic liquid was dissolved in 20 ml of acetone, the solution was poured into a cylindrical dropping funnel filled with neutral activated alumina, and acetone as a washing liquid, pressurized with an air pump, was passed therethrough to further wash the solution with the acetone. The resulting solution was subsequently concentrated with an evaporator, and the resulting ionic liquid was dried under reduced pressure for 1 hour at 80° C. with a liquid nitrogen trap attached thereto. The water content in the resulting ionic liquid was 12 ppm.

Note that the water content in 1-ethyl-3-methylimidazolium bis(fluorosulfonyl)imide before being subjected to the purification treatment was 53 ppm.

### Purification of Ionic Liquid 2

10 ml of 1-methyl-1-propylpyrrolidinium bis(fluorosulfonyl)imide, which is an ionic liquid composed of 1-methyl-1-propylpyrrolidinium cation and bis(fluorosulfonium)imide anion, was washed with hexane and ethyl acetate at a ratio of 5:1. 10 ml of the washed ionic liquid was dissolved in 20 ml of acetone, the solution was poured into a cylindrical dropping funnel filled with neutral activated alumina, and acetone as a washing liquid, pressurized with an air pump, was passed therethrough to further wash the solution with the acetone. The resulting solution was subsequently concentrated with an evaporator, and the resulting ionic liquid was dried under reduced pressure for 1 hour at 80° C. with a liquid nitrogen trap attached thereto. The water content in the resulting ionic liquid was 9 ppm.

Note that the water content in 1-methyl-1-propylpyrrolidinium bis(fluorosulfonyl)imide before being subjected to the purification treatment was 61 ppm.

### Example 1

### Preparation of Capacitor Composed of Anode/Electrolyte Composition 1/Cathode

The procedures were performed in a dry room (dew point in the room: −40° C. DP or lower, cleanliness level: Class 1,000).

<Preparation of Anode 1>

100 parts by mass of artificial graphite powder with a volume average particle diameter of 4 μm as an anode active material, 6 parts by mass, calculated as solids, of a solution of polyvinylidene fluoride in N-methylpyrrolidone, and 11 parts by mass of acetylene black as a conductive additive were mixed and dispersed in N-methylpyrrolidone to give a total solid concentration of 50% to prepare an electrode coating solution for an anode.

The electrode coating solution for an anode was applied onto 18-μm-thick copper foil using a doctor blade method, temporarily dried, and then rolled. The resulting electrode was cut into a size of 10×20 mm. The electrode had a thickness of about 50 μm. Before being assembled into a cell, the electrode was dried in vacuum at 120° C. for 5 hours.

<Doping of Anode with Lithium>

The anode obtained as described above was doped with lithium as follows: In a dry atmosphere, the anode and metal lithium foil were layered, and then a trace amount of a 1 mol/L solution of lithium bis(fluorosulfonyl)imide in 1-ethyl-3-methylimidazolium bis(fluorosulfonyl)imide as an electrolytic solution was injected between them to allow a predetermined amount of lithium ions to be intercalated into the anode over about 10 hours. The amount of lithium doped was about 75% the capacity of the anode.

<Preparation of Cathode 1>

As a cathode active material, activated carbon powder with a volume average particle diameter of 8 μm, i.e., alkali activated carbon obtained from a phenolic resin as a raw material, was used. To 100 parts by mass of the cathode active material were added 6 parts by mass, calculated as solids, of a solution of polyvinylidene fluoride in N-methylpyrrolidone and 11 parts by mass of acetylene black as a conductive additive, and these components were mixed and dispersed in N-methylpyrrolidone to give a total solid concentration of 50% with a disperser to prepare an electrode coating solution for a cathode.

The electrode coating solution for a cathode was applied onto a 15-μm-thick aluminum foil current collector using a doctor blade method, temporarily dried, and then rolled. The resulting electrode was cut into a size of 10×20 mm. The electrode had a thickness of 50 μm.

<Preparation of Electrolyte Composition 1>

10 parts by mass of the copolymer obtained in Polymerization Example 1, 1 part by mass of trimethylolpropane trimethacrylate, and 0.2 part by mass of 2-hydroxy-2-methyl-1-phenyl-propan-1-one as a photoreaction initiator were dissolved in 90 parts by mass of a solution in which dried lithium bis(fluorosulfonyl)imide was dissolved in 1-ethyl-3-methylimidazolium bis(fluorosulfonyl)imide purified in [Purification of Ionic Liquid 1] at a concentration of 1 mol/L to prepare an electrolyte composition 1.

<Formation of Electrolyte Composition Layer>

The composition for gel electrolyte 1 was applied onto the cathode sheet obtained in Preparation of Cathode 1 using a doctor blade to form a 10-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet from which the laminated covers had been removed were bonded to each other, and then the entire structure was covered with a laminated film to prepare a lithium-ion capacitor having a laminated cell shape. The completed cell was left standing for about 1 day until measurements were conducted. The water content in the composition for gel electrolyte sealed inside was 37 ppm.

### Example 2

### Preparation of Capacitor Composed of Anode/Electrolyte Composition 2/Cathode

An anode and a cathode were prepared as in Example 1.

<Preparation of Electrolyte Composition 2>

10 parts by mass of the copolymer obtained in Polymerization Example 2, 0.2 part by mass of 2-hydroxy-2-methyl-1-phenyl-propan-1-one as a photoreaction initiator, and 0.05 part by mass of 2-benzyl-2-dimethylamino-1-(4-morpholinophenyl)-butanone-1 were dissolved in 90 parts by mass of a solution in which dried lithium bis(fluorosulfonyl)imide was dissolved in 1-ethyl-3-methylimidazolium bis(fluorosulfonyl)imide purified in [Purification of Ionic Liquid 1] at a concentration of 1 mol/L to prepare an electrolyte composition 2.

<Formation of Electrolyte Composition Layer>

The composition for gel electrolyte 2 was applied onto the cathode sheet obtained in Preparation of Cathode 1 using a doctor blade to form a 10-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet. The anode sheet was treated in the same manner as the cathode to prepare an anode/electrolyte sheet in which a 10-μm-thick electrolyte composition layer was integrated onto the anode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet from which the laminated covers had been removed were bonded to each other, and then the entire structure was covered with a laminated film to prepare a lithium-ion capacitor having a laminated cell shape. The completed cell was left standing for about I day until measurements were conducted. The water content in the composition for gel electrolyte sealed inside was 35 ppm.

### Example 3

### Preparation of Capacitor Composed of Anode/Electrolyte Composition 3/Cathode

An anode and a cathode were prepared as in Example 1.

<Preparation of Electrolyte Composition 3>

10 parts by mass of the copolymer obtained in Polymerization Example 3, 0.2 part by mass of 1-[4-(2-hydroxyethoxy)-phenyl]-2-hydroxy-2-methyl-1-propan-1-one as a photoreaction initiator, 0.1 part by mass of 2-benzyl-2-dimethylamino-1-(4-morpholinophenyl)-butanone-1, and 3 parts by mass of resin particles (MZ-10HN; Soken Chemical & Engineering Co., Ltd.) were dissolved and dispersed in 90 parts by mass of a solution in which dried lithium bis(fluorosulfonyl)imide was dissolved in 1-ethyl-3 -methylimidazolium bis(fluorosulfonyl)imide purified in [Purification of Ionic Liquid 1] at a concentration of 1 mol/L to prepare an electrolyte composition 3.

<Formation of Electrolyte Composition Layer>

The composition for gel electrolyte 3 was applied onto the cathode sheet obtained in Preparation of Cathode 1 using a doctor blade to form a 15-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet from which the laminated covers had been removed were bonded to each other, and then the entire structure was covered with a laminated film to prepare a lithium-ion capacitor having a laminated cell shape. The completed cell was left standing for about 1 day until measurements were conducted. The water content in the composition for gel electrolyte sealed inside was 42 ppm.

### Example 4

### Preparation of Capacitor Composed of Anode/Electrolyte Composition 4/Cathode

An anode and a cathode were prepared as in Example 1.

<Preparation of Electrolyte Composition 4>

10 parts by mass of the copolymer obtained in Polymerization Example 4, 0.3 part by mass of 1-[4-(2-hydroxyethoxy)-phenyl]-2-hydroxy-2-methyl-1-propan-1-one as a photoreaction initiator, and 2 parts by mass of resin particles (EPOSTAR MA1010; Nippon Shokubai Co., Ltd.) were dissolved in 90 parts by mass of a solution in which dried lithium bis(fluorosulfonyl)imide was dissolved in 1-ethyl-3-methylimidazolium bis(fluorosulfonyl)imide purified in [Purification of Ionic Liquid 1] at a concentration of 1 mold, to prepare an electrolyte composition 4.

<Formation of Electrolyte Composition Layer>

The composition for gel electrolyte 4 was applied onto the cathode sheet obtained in Preparation of Cathode 1 using a doctor blade to form a 15-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet were bonded to each other, and then the entire structure was covered with a laminated film to prepare a lithium-ion capacitor having a laminated cell shape. The completed cell was left standing for about 1 day until measurements were conducted. The water content in the composition for gel electrolyte sealed inside was 40 ppm.

### Example 5

### Preparation of Capacitor Composed of Anode/Electrolyte Composition 5/Cathode

An anode and a cathode were prepared as in Example 1.

<Preparation of Electrolyte Composition 5>

10 parts by mass of the copolymer obtained in Polymerization Example 5, 0.2 part by mass of 1-[4-(2-hydroxyethoxy)-phenyl]-2-hydroxy-2-methyl-1-propan-1-one as a photoreaction initiator, and 0.15 part by mass of 2-(dimethylamino)-2-[(4-methylphenyl)methyl]-1-[4-(4-morpholinyl)phenyl]-1-buta-none were dissolved in 90 parts by mass of a solution in which dried lithium bis(fluorosulfonyl)imide was dissolved in 1 -methyl-1-propylpyrrolidinium bis(fluorosulfonyl)imide purified in [Purification of Ionic Liquid 2] at a concentration of 1 mol/L to prepare an electrolyte composition 5.

<Formation of Electrolyte Composition Layer>

The composition for gel electrolyte 5 was applied onto the cathode sheet obtained in Preparation of Cathode 1 using a doctor blade to form a 15-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet were bonded to each other, and then the entire structure was covered with a laminated film to prepare a lithium-ion capacitor having a laminated cell shape. The completed cell was left standing for about 1 day until measurements were conducted. The water content in the composition for gel electrolyte sealed inside was 29 ppm.

### Comparative Example 1

### Preparation of Capacitor Composed of Anode/Electrolyte Composition 6/Cathode

An anode and a cathode were prepared as in Example 1.

<Preparation of Electrolyte Composition 6>

10 parts by mass of the copolymer obtained in Comparative Polymerization Example 1, I part by mass of trimethylolpropane trimethacrylate, and 0.2 part by mass of 2-hydroxy-2-methyl-1-phenyl-propan-1-one as a photoreaction initiator were dissolved in 90 parts by mass of a solution in which lithium bis(fluorosulfonyl)imide was dissolved in unpurified 1-ethyl-3-methylimidazolium bis(fluorosulfonyl)imide at a concentration of 1 mol/L to prepare an electrolyte composition 6.

<Formation of Electrolyte Composition Layer>

The electrolyte composition 6 was applied onto the cathode sheet obtained in Preparation of Cathode 1 using a doctor blade to form a 10-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet were bonded to each other, and then the entire structure was covered with a laminated film to prepare a lithium-ion capacitor having a laminated cell shape. The completed cell was left standing for about 1 day until measurements were conducted. The water content in the electrolyte composition sealed inside was 94 ppm.

### Comparative Example 2

### Preparation of Capacitor Composed of Anode/Electrolyte Composition 7/Cathode

An anode and a cathode were prepared as in Example 1.

<Preparation of Electrolyte Composition 7>

10 parts by mass of the copolymer obtained in Comparative Polymerization Example 1, 1 part by mass of trimethylolpropane trimethacrylate, and 0.2 part by mass of 2-hydroxy-2-methyl-1-phenyl-propan-1-one as a photoreaction initiator were dissolved in 90 parts by mass of a solution in which lithium bis(fluorosulfonyl)imide was dissolved in unpurified 1-methyl-1-propylpyrrolidinium ‘bis(fluorosulfonyl)imide at a concentration of 1 mol/L to prepare an electrolyte composition 7.

<Formation of Electrolyte Composition Layer>

The electrolyte composition 7 was applied onto the cathode sheet obtained in Preparation of Cathode 1 using a doctor blade to form a 10-μm-thick electrolyte composition layer. Subsequently, the electrolyte composition layer was dried, and then cross-linked by being irradiated for 30 seconds with a high-pressure mercury lamp (30 mW/cm²) from GS Yuasa International Ltd., with the surface of the electrolyte being covered with a laminated film, to prepare a cathode/electrolyte sheet in which the electrolyte composition layer was integrated onto the cathode sheet.

The lithium-doped anode sheet was treated in the same manner as the cathode to prepare an anode/electrolyte sheet in which a 10-μm-thick electrolyte composition layer was integrated onto the anode sheet.

<Assembly of Capacitor Cell>

In a glove box purged with argon gas, the cathode/electrolyte sheet and the anode/electrolyte sheet were bonded to each other, and then the entire structure was covered with a laminated film to prepare a lithium-ion capacitor having a laminated cell shape. The completed cell was left standing for about 1 day until measurements were conducted. The water content in the composition for gel electrolyte sealed inside was 102 ppm.

<Electrochemical Evaluation of Lithium-Ion Capacitors>

For each of the lithium-ion capacitors obtained above, the power characteristics (the discharge capacity retention ratio (%) as the ratio of the discharge capacity at 100 C to the discharge capacity at 1 C) and the capacity retention ratio were evaluated. Both measurements were performed at 25° C. The results are shown in Table 2.

(Power Characteristics)

A charge/discharge test was performed as follows: A lithium-ion capacitor was charged at a predetermined current to 4.0 V using the constant current charge method, and discharged to 2.0 V at the same current as that during charge using the constant current discharge method. Using, as a reference, the current (1 C) at which the cell capacity can be discharged in 1 hour, the current at which the cell capacity can be discharged in 1/10 hour or 1/100 hour was similarly set to 10 C or 100 C, respectively. The “discharge capacity retention ratio as the ratio of the discharge capacity at 100 C to the discharge capacity at IC” was calculated according to the following equation. The values are shown in Table 2.

Discharge capacity retention ratio (%) as the ratio of the discharge capacity at 100 C to the discharge capacity at 1 C=(discharge capacity at the 5th cycle at 100 C) (discharge capacity at the 5th cycle at 1 C)×100

(Capacity Retention Ratio)

A cycling test was performed at 10 C. The charge/discharge cycling test was performed as follows: A lithium-ion capacitor was charged at 10 C to 4.0 ‘V using the constant current charge method, and discharged at 10 C to 2.0 V using the constant current discharge method. This procedure was taken as one cycle, and the lithium-ion capacitor was charged and discharged 1,000 cycles. In Table 2, “Capacity Retention Ratio (%)” refers to the ratio of the discharge capacity after 1,000 cycles to the initial discharge capacity.

TABLE 2

| | Discharge Capacity | Capacity Retention |
|---|---|---|
| | Retention Ratio (%) as Ratio of | Ratio (%) |
| | Discharge Capacity at 100 C to | after 1,000 Cycles at |
| | Discharge Capacity at 1 C | 10 C |
| Example 1 | 90 | 97 |
| Example 2 | 91 | 98 |
| Example 3 | 89 | 97 |
| Example 4 | 90 | 98 |
| Example 5 | 91 | 98 |
| Comparative | 83 | 89 |
| Example 1 | | |
| Comparative | 81 | 84 |
| Example 2 | | |

As shown in Table 4, it is seen that the lithium-ion capacitors of Examples 1 to 5 had high discharge capacity retention ratios as the ratios of the discharge capacity at 100 C to the discharge capacity at 1 C (i.e., had excellent power characteristics), and had high capacity retention ratios after 1,000 cycles.

1. A composition for gel electrolyte comprising an electrolyte salt and a polyether copolymer having an ethylene oxide unit, wherein the composition for gel electrolyte has a water content of 50 ppm or less.

2. The composition for gel electrolyte according to claim 1, wherein the electrolyte salt comprises an ambient temperature molten salt.

3. The composition for gel electrolyte according to claim 1, wherein the polyether copolymer comprises:
0 to 89.9 mol % of a repeating unit represented by Formula (A): 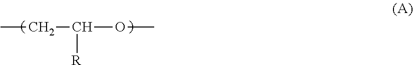
wherein R is a C₁₋₁₂ alkyl group or a —CH₂O(CR¹R²R³) group; R¹, R², and R³ are each independently a hydrogen atom or a —CH₂O(CH₂CH₂O)ₙR⁴ group; R⁴ is a C₁₋₁₂ alkyl group or an aryl group optionally having a substituent; and n is an integer from 0 to 12;
99 to 10 mol % of a repeating unit represented by Formula (B):
CH₂—CH₂—O (B)
; and
0.1 to 15 mol % of a repeating unit represented by Formula (C): 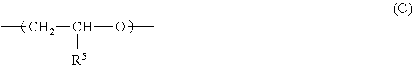
wherein R⁵ is a group having an ethylenically unsaturated group.

4. A method for producing the composition for gel electrolyte according to claim 1, comprising the step of:
mixing the electrolyte salt and the polyether copolymer, wherein
the electrolyte salt has a water content of 30 ppm or less.

5. A method for producing the composition for gel electrolyte according to claim 1, comprising the step of:
mixing the electrolyte salt and the polyether copolymer, wherein
the polyether copolymer has a water content of 200 ppm or less.

6. An electrochemical capacitor comprising, between a cathode and an anode, a gel electrolyte layer comprising a cured product of the composition for gel electrolyte according to claim 1.

7. The electrochemical capacitor according to claim 6, wherein the gel electrolyte layer has a thickness of 1 to 50 μm.

8. A method for producing an electrochemical capacitor comprising the steps of:
applying the composition for gel electrolyte according to claim 1 to a surface of at least one of a cathode and an anode;
forming a gel electrolyte layer by irradiating the composition for gel electrolyte with active energy rays to cure the composition for gel electrolyte; and
laminating the cathode and the anode with the gel electrolyte layer sandwiched therebetween.
